(19) United States
(12) Patent Application Publication
(10) Pub. No.: US 2017/0363653 A1
(43) Pub. Date: Dec. 21, 2017

(54) CAPPING SYSTEM FOR BIOLOGICAL THERMAL REACTION AND METHOD OF USING THE SAME

(71) Applicant: TAIGEN BIOSCIENCE CORPORATION, Taipei City (TW)

(72) Inventor: CHI-SHENG TAI, Taipei City (TW)

(21) Appl. No.: 15/597,081

(22) Filed: May 16, 2017

(30) Foreign Application Priority Data
Jun. 15, 2016 (TW) 105118760

(51) Int. Cl. G01N 35/02; G01N 35/00

(52) U.S. Cl. CPC G01N 35/026; G01N 35/0099; G01N 35/00693; G01N 2035/00346

(57) ABSTRACT

The present invention provides a capping system for biological thermal reaction, which comprises at least one reaction tube, at least one suction unit, and at least one pushing rod. Each of the at least one reaction tube comprises an opening end. The at least one suction unit is used to suck at least one cap and move the at least one cap to the opening end of the at least one reaction tube. The at least one pushing rob is used to push the at least one cap into the opening end of the at least one reaction tube.

### FIELD OF THE INVENTION

The present invention relates to a capping system for biological thermal reaction and a method of using the same, and in particular, is related to the biomedical industry, for applying on automated equipments.

### BACKGROUND OF THE INVENTION

In the biomedical laboratory, usually, reactants are usually put into a plastic reaction tube for generating biochemical reaction. It is common to seal the reaction tube for avoiding an influence from the external environment and keeping the consistency of the reaction condition. For bio-heat reactions, such as Polymerase Chain Reaction (PCR) needs to be processed over 90 Celsius degrees for several hours, whereby air-sealability is very important.

The conventional automated equipments applied for PCR use two kinds of methods for sealing the reaction tubes. 1. The reaction tubes are sealed by manual operation; and 2. The special-specification plastic tube and tools are used.

In the first method, during the operation of the automated equipments, the reaction tubes are token out to be sealed by manual operation. However, the manual operation might cause some reaction tubes sealed un-completely and time wasted.

In the second method, e.g. a Roch's COBAS Ampliprep is designed with the reaction tubes and caps having threads. It is found that although a sealability of the reaction tubes are ensured, a rotatable mechanism is needed for use, and furthermore, one cap is sealed for one operation; if multiple reaction tubes are simultaneously sealed, it is needed to use quite a few mechanisms, so that the manufacturing cost is raised. Meanwhile, the reaction tubes and caps with thread also means higher manufacturing cost (a common reaction tubes have no thread).

Furthermore, comparative with the first method, the second method is for a completely automated equipment. However, there are still several issues. 1. It is unable to know whether the cap is moved to the position of the reaction tube; 2. The cap might be slid down from the reaction tube when rotating; and 3. The rotatable mechanism is easily out of order.

Hence, it is essential to provide a capping system for biological thermal reaction and a method of using the same, so as to solve the above technical issues.

However, the conventional art provides solutions to the above-mentioned technical problems, but there is no effective way to solve the above-mentioned technical problems at the same time.

### SUMMARY OF THE INVENTION

In order to solve the aforementioned technical problems of the conventional art, an objective of the present invention is to provide suction units and pushing rods. When the suction units suck a cap, it is determined whether the cap is sucked according to a pressure-detection device, and the cap can be correctly reached to above the reaction tube. The respective pushing rods are aligned to each of caps, with performing a single direction movement, so as to accurately push each cap into each of the reaction tubes.

In order to achieve the objective, the present invention provides a capping system for biological thermal reaction, which comprises at least one reaction tube, at least one suction unit and at least one pushing rod.

Each of the at least one reaction tube comprises an opening end. The at least one suction unit is used for sucking at least one cap and moving the at least one cap to reach above the opening end of the at least one reaction tube. The at least one pushing rod is used for pushing the at least one cap into the opening end of the at least one corresponding reaction tube.

In a preferred embodiment, the capping system further comprises a pressure-detection device for determining whether the at least one suction unit sucks the at least one cap completely or not.

In a preferred embodiment, the capping system further comprises a calibrating device for aligning the at least one suction unit with the at least one cap for a sucking process, for moving the at least one cap in alignment with the at least one reaction tube for performing a moving process, and for aligning the at least one rod with the at least one cap for performing a pushing process which pushes the at least one cap into the opening end of the at least one corresponding reaction tube.

In a preferred embodiment, the capping system further comprises a driving device for actuating the at least one rod to perform a pushing process which pushes the at least one cap into the opening end of the at least one corresponding reaction tube.

In a preferred embodiment, the capping system further comprises an air-pressure device for providing an enough suction pressure for the at least one suction unit.

In a preferred embodiment, the capping system further comprises a pressure-relief device for eliminating a suction pressure of the at least one suction unit, so as to make the at least one cap departed from the at least one suction unit.

In a preferred embodiment, the capping system is used for bio-heat reaction over 90 Celsius degrees.

In order to achieve the object, the present invention provides a capping method for biological thermal reaction, which comprises steps of: at least one reaction tube being disposed wherein each of the at least one reaction tube comprises an opening end; next, at least one cap being sucked by at least one suction unit to move to reach above the opening end of the at least one reaction tube; and the at least one cap being pushed by at least one pushing rod into the opening end of the at least one reaction tube.

In a preferred embodiment, the capping method further comprises a step of: whether the at least one suction unit sucks the at least one cap completely or not being determined by a pressure-detection device

In a preferred embodiment, the capping method further comprises a calibrating device for aligning the at least one suction unit with the at least one cap for performing a sucking process, for moving the at least one cap in alignment with the at least one reaction tube for performing a moving process, and for aligning the at least one rod with the at least one cap for performing a pushing process which pushes the at least one cap into the opening end of the at least one corresponding reaction tube.

In a preferred embodiment, the capping method further comprises a step of using a driving device for actuating the at least one rod to perform a pushing process which pushes the at least one cap into the opening end of the at least one corresponding reaction tube.

In a preferred embodiment, the capping method further comprises a step of using an air-pressure device for providing an enough suction pressure for the at least one suction unit.

In a preferred embodiment, the capping method further comprises a step of: using a pressure-relief device to eliminate a suction pressure of the at least one suction unit, to make the at least one cap departed from the at least one suction unit.

In a preferred embodiment, the capping method is used for bio-heat reaction over 90 Celsius degrees.

Compared with the conventional art, the present invention provides suction units and pushing rods. When the suction units suck a cap, whether the cap is sucked is determined according to a pressure-detection device. The respective pushing rods are aligned with each of caps and perform a single direction movement, so as to accurately push each cap into each of reaction tubes.

### DESCRIPTION OF THE DIAGRAMS

The technical solution and the beneficial effects of the present invention are best understood from the following detailed description with reference to the accompanying figures and embodiments.

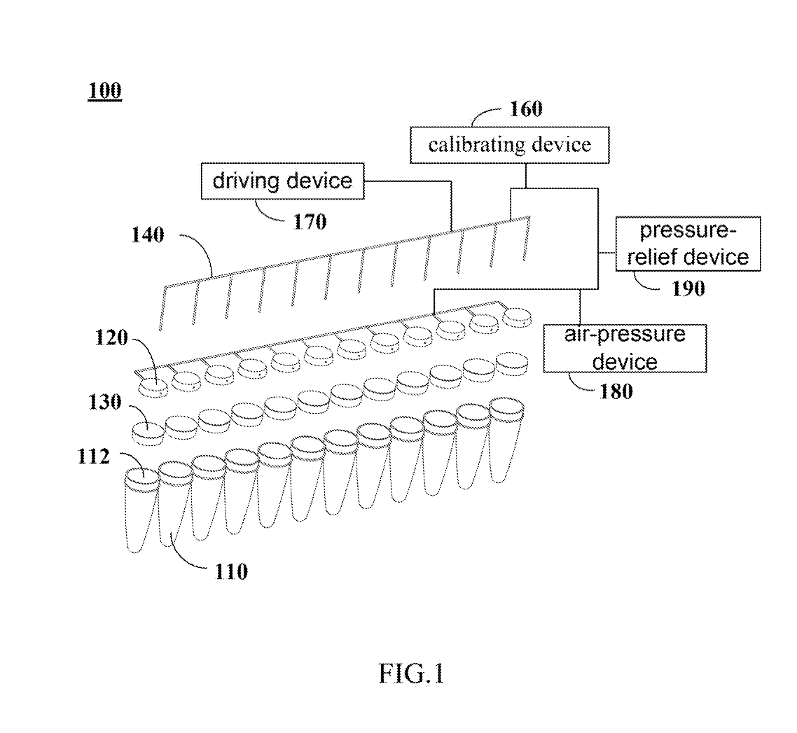

FIG. 1 is a disassembled schematic diagram of a capping system of a first preferred embodiment according to the present invention;

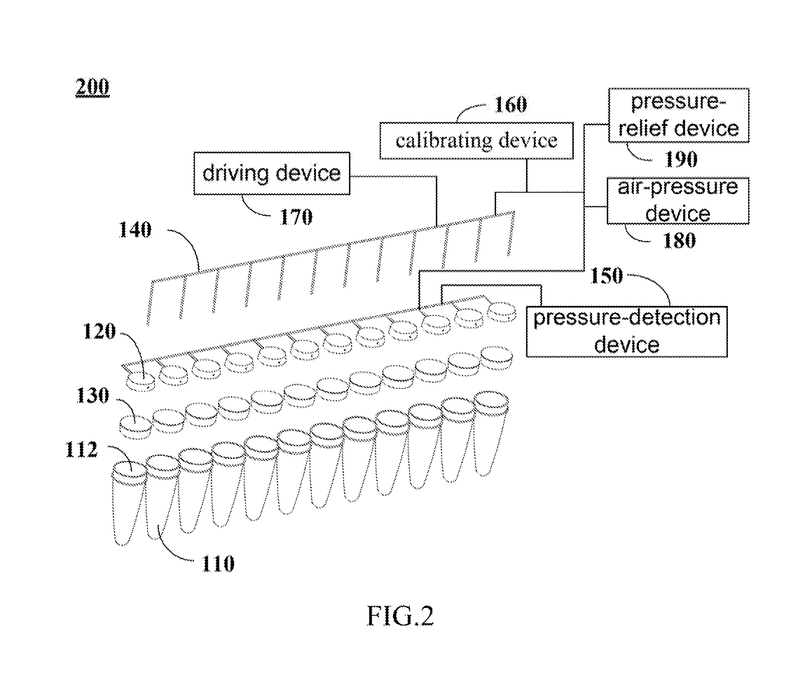

FIG. 2 is a disassembled schematic diagram of a capping system of a second preferred embodiment according to the present invention;

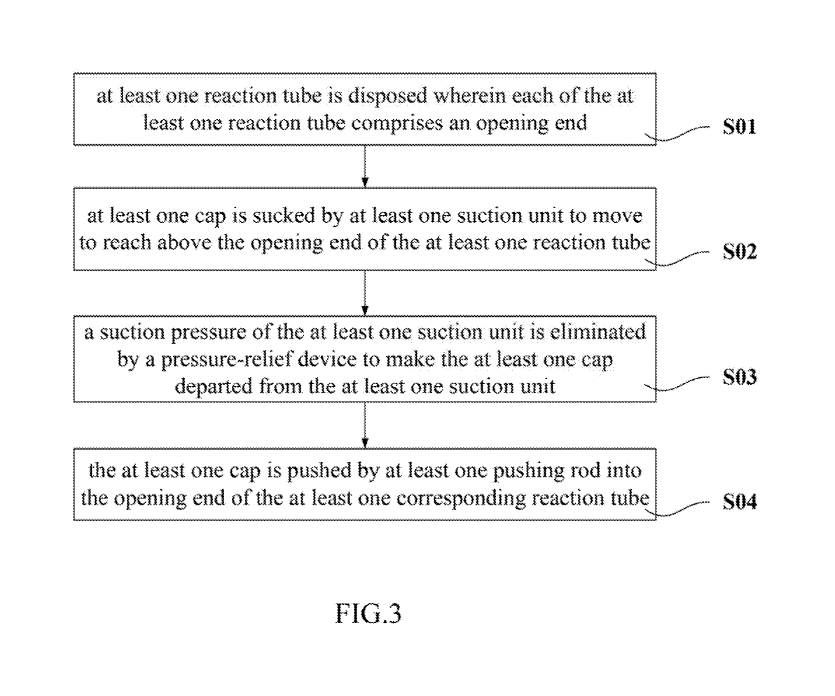

FIG. 3 is a flow diagram of a capping method of a first preferred embodiment according to the present invention; and

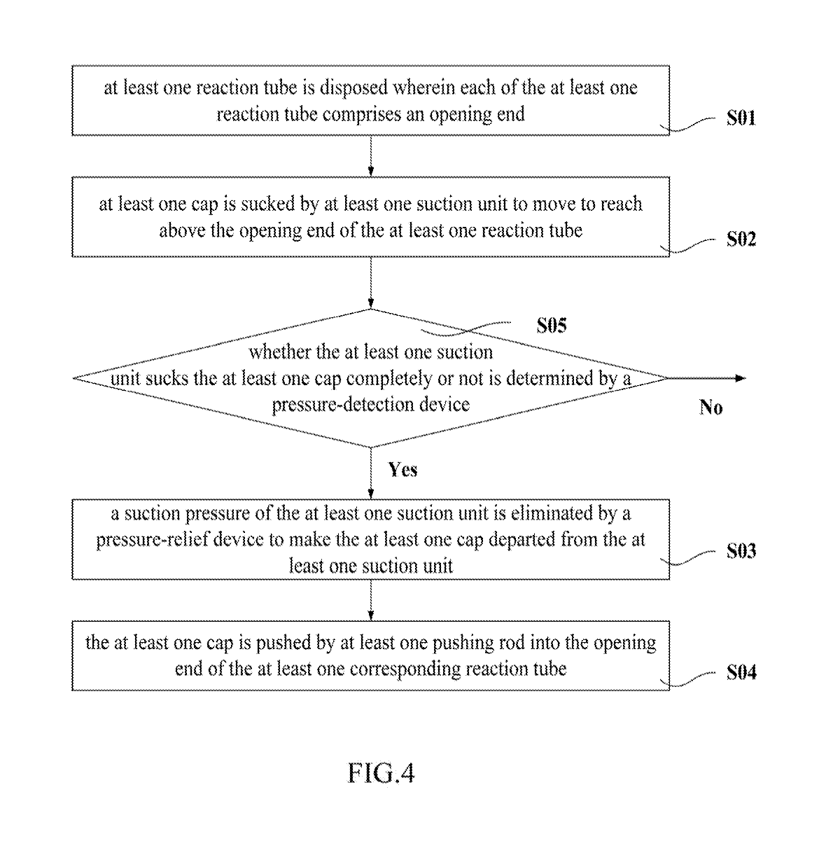

FIG. 4 is a flow diagram of a capping method of a second preferred embodiment according to the present invention.

### DETAILED DESCRIPTION OF THE PREFERRED EMBODIMENTS

The following description of the embodiments is given by way of illustration with reference to the specific embodiments in which the invention may be practiced. The terms such as “up”, “down”, “front”, “back”, “left”, “right”, “inside”, “outside”, “side”, etc., The direction of the diagram. Accordingly, the use of a directional term is used to describe and to understand the present invention and is not intended to limit the invention.

FIG. 1 is a disassembled schematic diagram of a capping system 100 of a first preferred embodiment according to the present invention. The capping system 100 comprises at least one reaction tube 110, at least one suction unit 120, at least one pushing rod 140, a calibrating device 160, a driving device 170, an air-pressure device 180 and a pressure-relief device 190.

Each of the at least one reaction tube 110 comprises an opening end 112. In detail, the opening end 112 is used to store materials for bio-heat reaction. The bio-heat reaction is performed over 90 Celsius degrees. The at least one suction unit 120 is used for sucking at least one cap 130 and moving the at least one cap 130 to reach above the opening end 112 of the at least one reaction tube 110. The pressure-relief device 190 is used for eliminating a suction pressure of the at least one suction unit 120 to make the at least one cap 130 departed from the at least one suction unit 120. Before the suction pressure of the at least one suction unit 120 is eliminated, the at least one cap 130 is unable to be departed from the at least one suction unit 120. The at least one cap 130 and/or the at least one suction unit 120 might be damaged to cause its air sealability decreased if an external forces is applied to depart the at least one suction unit 120 from the at least one cap 130. With the pressure-relief device 190, a pressure generated between the at least one suction unit 120 and the at least one cap 130 can recover as same as the ambient pressure so that the at least one cap 130 can be departed from the at least one suction unit 120, automatically. In detail, once the at least one cap 130 is accurately pushed into the at least one reaction tube 110, the air-sealability of the at least one reaction tube 110 can be ensured. The at least one pushing rod 140 is used for pushing the at least one cap 130 into the opening end 112 of the at least one corresponding reaction tube 110. Alternatively, with different mechanical design, it is possible to push the cap(s) into one (or multiple) reaction tubes 110.

The calibrating device 160 is used for aligning the at least one suction unit 120 with the at least one cap 130 for performing a sucking process, for moving the at least one cap 130 in alignment with the at least one reaction tube 110 for performing a moving process, and for aligning the at least one rod 140 with the at least one cap 130 for performing a pushing process, to make the at least one cap 130 into the opening end 112 of the at least one corresponding reaction tube 110.

In detail, the calibrating device can align the position with laser. The driving device 170 is used for actuating the at least one rod 140 to perform a pushing process, so as to make the at least one cap 130 into the opening end 112 of the at least one corresponding reaction tube 110. In detail, the driving device 170 can be one or a combination of air-actuation device and oil-actuation device. The air-pressure device 180 is used for providing an enough suction pressure for the at least one suction unit 120. In detail, the air-pressure device 180 can be vacuum pump or a device for extracting air.

Preferably, the driving device 170 can be incorporated into the air-pressure device 180, the pushing rods 140 performs the pushing process with the force provided by the air-pressure device, so as to push the at least one cap 130 into the opening end 112 of the at least one corresponding reaction tube 110.

In actual operation, first, the reactants are disposed inside the at least one reaction tube 110; then, the calibrating device 160 aligns the position of the at least one reaction tube 110; next, the at least one suction unit 120 sucks the at least one cap 130 and moves the at least one cap 130 to reach above the opening end 112 of the at least one reaction tube 110 (which just relies thereon but is not sealed yet by the cap); next, the pressure-relief device 190 eliminates the suction pressure of the at least one suction unit 120 to make the at least one cap 130 departed from the at least one suction unit 120; next, the at least one pushing rod 140 simultaneously pushes the at least one cap 130 into the opening end 112 of the at least one corresponding reaction tube 110, to form an air-tight sealing. Next, the reaction tube 110 can be used for bio-chemistry experiments. In the above operation process, with a linear operation (down-press movement) of the at least one pushing rod 140, the automatic bio-heat reaction equipment can accomplish a complete automation and raise its sealing speed. Generally speaking, a bio-heat reaction over 90 Celsius degrees requires a very high level of air-sealability, the capping system of the present invention can be structured in air-tight sealing to ensure the safety of the high temperature bio-heat reaction (over 90 Celsius degrees).

FIG. 2 is a disassembled schematic diagram of a capping system 200 of a second preferred embodiment according to the present invention. A difference of the second preferred embodiment from the first preferred embodiment is adding of one pressure-detection device 150. In the first preferred embodiment, the at least one cap 130 is sucked by the air-pressure device 180, so that it is possible that some of the caps may be not sucked. The pressure-detection device 180 is used to determine whether the at least one suction unit 120 sucks the at least one cap 130 completely or not. In detail, when the at least one suction unit 120 completely sucks the at least one cap 130, the pressure-detection device 180 will detect a specific vacuum degree; on the contrary, when the at least one suction unit 120 does not suck the at least one cap 130, the pressure-detection device 180 will detect atmospheric pressure, the operator can notice the error and correct it.

FIG. 3 is a flow diagram of a capping method of a first preferred embodiment according to the present invention (wherein the numerals of the elements are referred to FIG. 1). First, by performing a step S01, at least one reaction tube 110 is disposed wherein each of the at least one reaction tube 110 comprises an opening end 112; next, by performing a step S02 at least one cap 130 is sucked by at least one suction unit 120 to move to reach above the opening end 112 of the at least one reaction tube 110; next, by performing a step S03, a suction pressure of the at least one suction unit 120 is eliminated by a pressure-relief device 190 to make the at least one cap 130 departed from the at least one suction unit 120; and finally, by performing a step S04, the at least one cap 130 is pushed by at least one pushing rod 140 into the opening end 112 of the at least one corresponding reaction tube 110.

FIG. 4 is a flow diagram of a capping method of a second preferred embodiment according to the present invention (the numerals of the elements are referred to FIG. 1). A difference of the second preferred embodiment from the first preferred embodiment, further comprises a step S05 between the step S02 and the step S03. In the step S05, whether the at least one suction unit 120 sucks the at least one cap 130 completely or not is determined by a pressure-detection device 150. In detail, when the pressure-detection device 180 detects a specific vacuum degree, then the step S03 is performed; on the contrary, when the at least one suction unit 120 does not suck the at least one cap 130, the pressure-detection device 180 will detect atmospheric pressure, the operator can notice the error and correct it, rather than performing the step S03 to cause the equipment damaged.

As described above, although the present invention has been described with the preferred embodiments thereof, those skilled in the art will appreciate that various modifications, additions, and substitutions are possible without departing from the scope and the spirit of the invention. Accordingly, the scope of the present invention is intended to be defined only by reference to the claims.

What is claimed is:

1. A capping system for biological thermal reaction, comprising:
at least one reaction tube wherein each of the at least one reaction tube comprises an opening end;
at least one suction unit for sucking at least one cap and moving the at least one cap to reach above the opening end of the at least one reaction tube; and
at least one pushing rod for pushing the at least one cap into the opening end of the at least one corresponding reaction tube.

2. The capping system according to claim 1, further comprising a pressure-detection device for determining whether the at least one suction unit sucks the at least one cap completely or not.

3. The capping system according to claim 1, further comprising a calibrating device for aligning the at least one suction unit with the at least one cap for performing a sucking process, for moving the at least one cap in alignment with the at least one reaction tube for performing a moving process, and for aligning the at least one rod with the at least one cap for performing a pushing process which pushes the at least one cap into the opening end of the at least one corresponding reaction tube.

4. The capping system according to claim 1, further comprising a driving device for actuating the at least one rod to perform a pushing process which pushes the at least one cap into the opening end of the at least one corresponding reaction tube.

5. The capping system according to claim 1, further comprising an air-pressure device for providing an enough suction pressure for the at least one suction unit.

6. The capping system according to claim 1, further comprising a pressure-relief device for eliminating a suction pressure of the at least one suction unit, to make the at least one cap departed from the at least one suction unit.

7. The capping system according to claim 1, wherein the capping system is used for biological thermal reaction over 90 Celsius degrees.

8. A capping method for biological thermal reaction, comprising steps of:
disposing at least one reaction tube wherein each of the at least one reaction tube comprises an opening end;
using at least one suction unit to suck at least one cap and move the at least one cap to reach above the opening end of the at least one reaction tube; and
pushing the at least one cap by at least one pushing rod into the opening end of the at least one corresponding reaction tube.

9. The capping method according to claim 8, further comprising a step of:
using a pressure-detection device to determine whether the at least one suction unit sucks the at least one cap completely or not.

10. The capping method according to claim 8, further comprising a step of using a calibrating device for aligning the at least one suction unit with the at least one cap for performing a sucking process, for moving the at least one cap in alignment with the at least one reaction tube for performing a moving process, and for aligning the at least one rod with the at least one cap for performing a pushing process which pushes the at least one cap into the opening end of the at least one corresponding reaction tube.

11. The capping method according to claim 8, further comprising a step of using a driving device for actuating the at least one rod to perform a pushing process which pushes the at least one cap into the opening end of the at least one corresponding reaction tube.

12. The capping method according to claim 8, further comprising a step of using an air-pressure device for providing an enough suction pressure for the at least one suction unit.

13. The capping method according to claim 8, further comprising a step of:
eliminating a suction pressure of the at least one suction unit by a pressure-relief device, to make the at least one cap departed from the at least one suction unit.

14. The capping method according to claim 8, wherein the capping method is used for biological thermal reaction over 90 Celsius degrees.
